(19) United States
(12) Patent Application Publication
(10) Pub. No.: US 2002/0001135 A1
(43) Pub. Date: Jan. 3, 2002

(54) High efficiency prism assembly for image projection

(76) Inventors: Arthur L. Berman, San Jose, CA (US); Edmund Sandberg, Monte Sereno, CA (US)

Correspondence Address: GARY CARY WARE & FREIDENRICH, 1755 EMBARCADERO, PALO ALTO, CA, 94303-3340, US

(21) Appl. No.: 09/818,087

(22) Filed: Mar. 26, 2001

Related U.S. Application Data
(60) Provisional application No. 60/192,258, filed on Mar. 27, 2000.
(60) Provisional application No. 60/225,242, filed on Aug. 15, 2000.

(51) Int. Cl. G02B 27/12

(52) U.S. Cl. 359/640; 359/639

(57) ABSTRACT

A high efficiency prism is provided that directs one or more color components (e.g., red, green and blue) of light through one or more different light paths to generate a color image. One or more different embodiments of the prism are shown including several in-line embodiments, several right-angle embodiments, a high light output embodiment, an air gap embodiment and several liquid filled embodiments.

This application claims the benefit of the following U.S. Provisional Applications: U.S. Provisional Application Nos. 60/192,258 filed Mar. 27, 2000 and 60/225,242 filed Aug. 15, 2000. All of these provisional applications are hereby incorporated by reference in their entireties.

### BACKGROUND OF THE INVENTION

This invention relates generally to an optical component for an image projection system and in particular to a prism assembly for an image projection system.

To generate an image and project it onto a screen, an image projection apparatus is used which may be known as a light engine. The light engine may be used for various types of direct view display devices including televisions, high definition televisions, monitors and front screen projectors. A typical light engine may include a broad band light source, a condenser (to collect the light from the broad band light source), optics to direct the light output from the condenser, a projection lens for focusing the light outputted from the optics, mirrors (which may redirect the light) and a screen (which may be suitable for either front or rear projection) onto which the generated image is displayed. The optics may typically include a prism.

The prism performs several different functions. In particular, it polarizes the incoming white light and physically divides the input light into three spectra bands wherein the three spectral bands typically fall into the red, green and blue portions of the light spectrum. Within the prism, the portion of the light in each band follows a different light path/channel through the prism. The light path for the red portion of the light may be known as the red light path, the light path from the blue portion of the light may be known as the blue light path and the light path for the green portion of the light may be known as the green light path. In each light path, the light is directed by the prism to a particular reflective microdisplay (e.g., a red microdisplay, a separate blue microdisplay and a separate green microdisplay). The images on each microdisplay (corresponding to the image for the particular color for the particular image) is controlled by drive electronics that are also part of the light engine. In each light path, the light is modulated (e.g., its polarization is changed) and reflected by the microdisplay according to the image on the microdisplay so that a red image, a blue image and a green image are separately formed. The prism then recombines these different color images from the different light paths back into a single full color beam. The single full color beam then exits the prism, enters the projection lens and is displayed.

For any display technology system to be successful for a particular application, it must enable various product characteristics. For example, the system should be physically compact and lightweight and the generated image should be sufficiently large. The generated image should have an acceptably high contrast ratio and should be sufficiently bright. The generated image should also have an acceptable color range, white point and resolution. The image should also be free from visual defects and other artifacts wherein the artifacts may include but are not limited to flicker, distortion and color non-uniformity. The system should be inexpensive to manufacture, have minimal maintenance and have acceptable reliability. Typical display technologies used to date have had at least one serious drawback as summarized in the following table:

| | DISPLAY | |
|---|---|---|
| APPLICATION | TECHNOLOGY | DISADVANTAGE |
| HDTV | Direct view CRT. | Not available in larger sizes or at |
| | | higher resolutions. Inherently |
| | | bulky, heavy and expensive. |
| | Direct view | Not available at higher |
| | plasma panel. | resolutions. Sizes above 70” |
| | | are unlikely to be available. |
| | | Inherently expensive. |
| | Direct view | Not available in larger sizes. |
| | AMLCD. | Inherently expensive. |
| | Rear projection | Larger CRT displays result in |
| | based on multi- | larger optics and a high volume |
| | channel CRTs | product that, as a consequence, |
| | | is inherently expensive. |
| | Rear projection | Larger AMLCDs result in larger |
| | based on multi- | optics and a high volume |
| | channel trans- | product that, as a consequence, |
| | missive AMLCDs. | is inherently expensive. |
| | | Inherently large “grout lines” |
| | | reduce transmission and image |
| | | quality. |
| | Rear projection | Color break up and low |
| | based on a trans- | brightness. Inherently large |
| | missive, time | “grout lines” reduce |
| | sequential AMLCD. | transmission and image quality. |
| Monitor | Direct view CRT. | Not available in larger sizes |
| (>25” | | or at higher resolution. |
| diagonal) | | Inherently bulky, heavy, |
| | | and expensive. |
| | Direct view | Not available in higher sizes. |
| | AMLCD. | Inherently expensive. |
| | Rear projection | Larger CRTs result in larger |
| | based on multi- | optics and a higher volume |
| | channel CRTs. | product that is inherently |
| | | expensive. |
| | Rear projection | Larger AMLCDs result in larger |
| | based on multi- | optics and a higher volume |
| | channel, trans- | product that is inherently |
| | missive AMLCDs. | expensive. Inherently large |
| | | “grout lines” reduce |
| | | transmission and image quality. |
| | Rear projection | Color break up and low bright- |
| | based on a trans- | ness. Inherently large “grout |
| | missive, time | lines” reduce transmission |
| | sequential AMLCD. | and image quality. |
| Portable Front | Front projection | Larger CRTs result in larger |
| Screen Projector | based on multi- | optics and a heavier, higher |
| | channel CRTs. | volume product that is inherently |
| | | expensive. |
| | Front projection | Larger AMLCDs result in larger |
| | based on trans- | optics and a heavier, higher |
| | missive, multi- | volume product that is inherently |
| | channel AMLCDs. | expensive. Inherently large |
| | | “grout lines” reduce |
| | | transmission and image quality. |
| | Front projection | Color break up and low bright- |
| | based on a trans- | ness. Inherently large “grout |
| | missive, time | lines” reduce transmission |
| | sequential AMLCD. | and image quality. |

Thus, it is desirable to provide a high efficiency prism for image projection that overcomes the above problems and limitations of conventional display technologies and it is to this end that the present invention is directed.

### SUMMARY OF THE INVENTION

The various embodiments of the prism in accordance with the invention incorporates various desirable features. For example, the contrast ratio is enhanced through the use of “rotated” quarter waveplates located between each of the polarized beam splitters and the microdisplays. In addition, simple modifications in the design will allow the f# to be optimized for various applications. The optical path lengths of the red, green and blue channels are designed to be equal which assures that the input light focuses on each microdisplay. It also assures that each microdisplay is in focus for the same position of the projection lens. One technique in accordance with the invention to adjust the optical path length (and so assure equal path lengths) is to include one or more spacer glasses wherein the specific thickness and location of the spacer glasses are chosen to equalize the path lengths. Another technique in accordance with the invention to adjust the optical path length is to displace the two triangular glass pieces that make up the polarized beam splitter (PBS) cubes.

In most configurations in accordance with the invention, at least some of the prism components are glued together and the index of refraction of the glue is chosen to match that of the components which reduces light loss due to Fresnel reflections. In one configuration of the prism, the polarizer/retarder stacks are not glued to other components. Instead, the stacks are laminated between cover glasses and separated from the other components by air gaps which reduces the assembly and operational stress on the stacks. To implement this approach, the outer surfaces of the cover glasses (as well as the faces of adjacent components) are anti-reflective (AR) coated. The positions of the components are fixed by a base plate. In the design of the base plate, the thickness of the air gaps between the components are chosen so as to equalize the optical path in each of the three channels. In accordance with the invention, the dichroic thin films can be coated onto a separate spacer glass or directly onto the PBS components. In addition, the back focal length is minimized in order to relax the requirements placed on the projection lens. Furthermore, the cost of the prism is kept low by minimizing the number of glass components and component cost is further minimized by utilizing simple triangular/square glass shapes.

In accordance with the invention, the light paths in the prism are designed such that the light is incident on the dichroics at a right angle which minimizes phase errors and chromatic effects. In addition, the “dump” and scattered light are effectively managed so as to prevent heating and maintain a high contrast ratio. In one embodiment, the dump face is AR coated and a black absorber is placed a small distance from the face which eliminates any possibility of heating. In accordance with the invention, the temperature of the light engine is controlled to prevent drift in the characteristics of the projected image. In addition, the physical size of the components have been adjusted in order to facilitate cost-effective, automatic assembly of the prism. Furthermore, reflective UV/IR filters may be mounted at or on the input face of the prism to remove/reflect ultra violet and infrared light.

To increase contrast, it is possible to introduce one or more additional clean-up polarizers into the prism. In the preferred embodiment, the location of the clean-up polarizer is in the green channel and this location was chosen to minimize the exposure of the polarizer material to harmful UV/blue light. The specific placement of the clean-up polarizer(s) determines if the best choice is to use an absorptive or a reflective polarizer material. In the preferred embodiment, a reflective clean-up polarizer was used since the light transmission of such polarizers is very high and the light absorption is very low.

In accordance with the invention, various prism configurations are possible. For example, the prism can incorporate a reflective microdisplay that utilizes any one of several electro-optic effects including but not limited to: mixed mode TN, ferroelectric, surface mode and folded surface mode. The prism may also incorporate microdisplays with a range of aspect ratios including but not limited to 4:3, 5:4, 16:9 and 16:10. The prism is compatible with a variety of light sources which may include, but is not limited to, the Fusion Lighting ByteLight, the mercury arc lamp (with or without doping), metal halide, xenon, LED array, three color laser or light brought to the condenser by a fiber optic. The polarization of the red, green and blue light output by the prism/light engine can be independently controlled (e.g., one possibility is that all polarizations are along the same axis). The prism can be configured such that the relationship between the input and the output light is either “in-line” or 90°. Also note that it is possible to rotate the body of the light source around the long axes of the condenser. It is also possible to include a turning mirror in the condenser and, by so doing, aligning the body of the light source at 90° to the condenser. These configuration options allow a wide range of “packages” for the light engine.

In accordance with another aspect of the invention, an enhanced brightness configuration prism may be created. In accordance with yet another aspect of the invention, an air gap embodiment may be used which further reduces the heating of the prism. In accordance with another aspect of the invention, two different liquid filled embodiments are described.

Thus, in accordance with the invention, a high efficiency prism for directing one or more color components of light to generate a color image is provided. The prism comprises an input polarizing beam splitter for separating incoming unpolarized light into a beam having a first polarization and a beam having a second polarization and a first color selection layer at the exit point of the first polarization beam for transmitting a first color light. The prism further comprises a first color polarizing beam splitter into which the first color light is received, the first polarizing beam splitter directing the first color light towards a first color microdisplay and the first color microdisplay reflecting the first color light and changing its polarization to generate an altered first color beam. The prism further comprises a second color selection layer at the exit point of the second polarization beam for transmitting the second and third color light, a second and third color polarizing beam splitter that receives the second and third color light, the second and third color polarizing beam splitter for directing the second color light towards a second microdisplay and for directing the third color light towards a third microdisplay wherein the second microdisplay reflects the second color light and changes its polarization to generate an altered second color light and the third microdisplay reflects the third color light and changes its polarization to generate an altered third color light. The prism further comprises an output polarizing beam splitter into which the altered first color beam, the altered second color beam and the altered third color beam are received, the third polarizing beam splitter recombining the altered color beams to generate a full color beam and directing the full color beam to an output.

In accordance with another aspect of the invention, a high efficiency prism for directing one or more color components of light to generate a color image is provided. The prism comprises an enclosure, a first polarized beam splitter element attached to the enclosure and a second polarized beam splitter element attached to the enclosure at substantially a right angle to the first polarized beam splitter element, the first and second polarized beam splitter elements separating the enclosure into four equal portions. Each portion of the prism further comprises a wall region in between the two polarized beam splitter elements wherein each wall region further comprises a color selection layer and the enclosure has one or more transparent windows in the walls of the enclosure. The prism further comprises a first microdisplay connected to a window for reflecting light having a first color, a second microdisplay connected to another window for reflecting light having a second color, and a third microdisplay connected to another window for reflecting light having a third color.

### BRIEF DESCRIPTION OF THE DRAWINGS

FIG. 1 is a diagram illustrating a first embodiment of the prism in accordance with the invention having an in-line configuration;

FIG. 2 is a diagram illustrating a second embodiment of the prism in accordance with the invention having an in-line configuration with a displaced input cube;

FIG. 3 is a diagram illustrating a third embodiment of the prism in accordance with the invention having another in-line configuration;

FIG. 4 is a diagram illustrating a fourth embodiment of the prism in accordance with the invention having a right angle configuration;

FIG. 5 is a diagram illustrating the fourth embodiment of the prism in accordance with the invention having a right angle configuration illustrating the features of the waste light management;

FIG. 6 is a diagram illustrating a fifth embodiment of the prism in accordance with the invention having another right angle configuration;

FIG. 7 is a diagram illustrating a sixth embodiment of the prism in accordance with the invention having yet another right angle configuration;

FIG. 8 is a diagram illustrating an seventh embodiment of the prism in accordance with the invention having a high light output configuration;

FIG. 9 is a diagram illustrating a eight embodiment of the prism in accordance with the invention having an air gap;

FIG. 10 is a diagram illustrating a ninth embodiment of the prism in accordance with the invention that is liquid filled; and

FIG. 11 is a diagram illustrating an tenth embodiment of the prism in accordance with the invention that is a liquid filled prism.

### DETAILED DESCRIPTION OF A PREFERRED EMBODIMENT

The invention is particularly applicable to a prism used for an image projection system and it is in this context that the invention will be described. It will be appreciated, however, that the prism in accordance with the invention has greater utility, such as to any other image generation applications. For all of the embodiments of the prism that will be described herein, the principle purpose of the prism is to direct white light from a light source to an image surface. The prism typically separates the light into different color components, typically red, green and blue, and possible different polarization components. The prism then processes each color component separately including reflecting the color component light off of a microdisplay to generate an image for the particular color component. Then, the color components with the images from the microdisplays are recombined to generate a full color image that is displayed on an image surface, such as a projection screen by a projection lens. Now, a first embodiment of the star prism in accordance with the invention will be described.

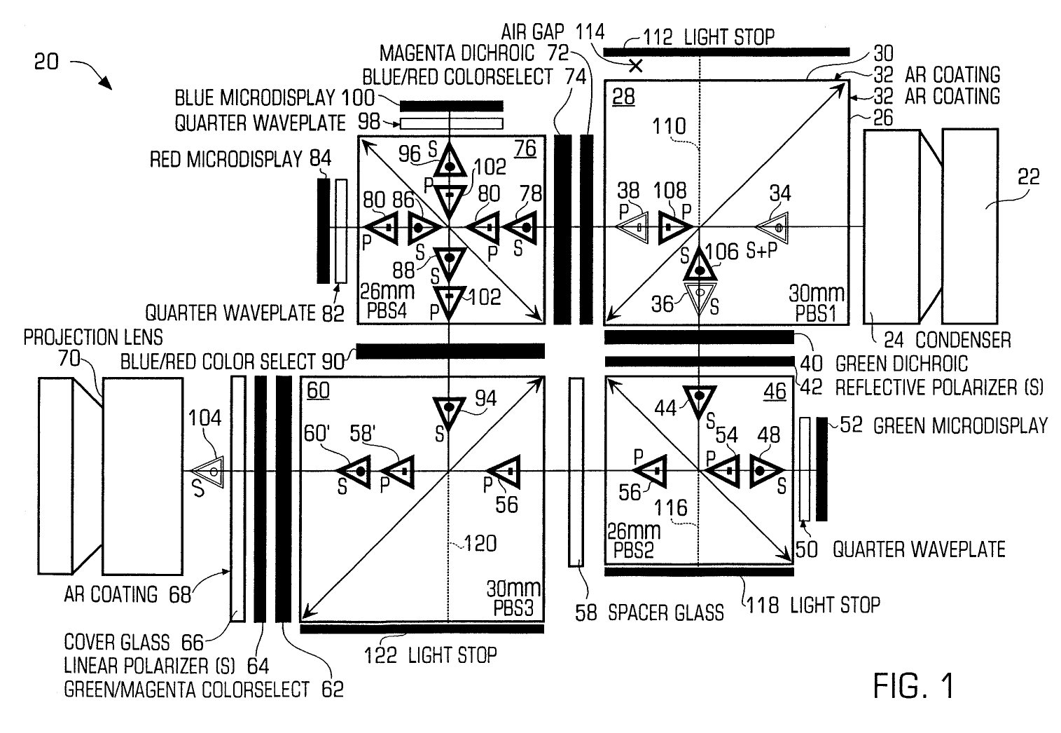

FIG. 1 is a diagram illustrating a first embodiment of a prism 20 in accordance with the invention having an in-line configuration. A broad spectrum of unpolarized white light may be generated a light source 22 and a condenser 24 and fed into the prism 20 through a front face 26 of a first polarized beam splitter (PBS1) 28. In accordance with the invention, the front face 26 and a side face 30 of the beam splitter may be coated with an antireflective coating 32. The light that enters PBS1 has both polarization components (shown as S+P) since it is unpolarized unlike some conventional prisms that require polarized input light. For purposes of this description and the accompanying drawings, the S and P polarized beams are depicted as triangles with an S or P (or both S and P) next to them and the tip of the triangle points in the direction of travel of the beam.

Prior to describing the other components of the prism, the functioning of a polarized beam splitter (PBS) should be explained. In particular, when unpolarized light enters a PBS, almost all of the S polarized light is reflected and almost none is transmitted. On the other hand, only about 95% of the P polarization is transmitted with the balance being reflected. The net effect of the PBS is that the S polarization light is “polluted” with 5% of the P polarized light. As will be described below, an effort is made to remove that pollution. In the figures, each PBS has a beam splitter element which is shown as a solid line with arrows at each end to distinguish it from the light beams.

Green Light Path

Returning to FIG. 1, an unpolarized light beam 34 from the light source strikes the beam splitter surface where the S polarization light is reflected downloads as an S polarization beam 36 with some small portion of P polarization light and the P polarization light is transmitted through the surface as a beam 38. Following the S polarization beam 36, it exits PBS1, passes through a green dichroic 40 that passes/transmits only the green portion of the light and a reflective polarizer 42 that cleans up the beam and removes the unwanted P polarization as an S polarized beam 44. That cleaned-up beam 44 then enters a second PBS (PBS2) 46. Since the light is S polarized, it is reflected to the right by the beam splitter element and forms a beam 48. The beam 48 passes through a quarter waveplate 50 that improves the contrast ratio of the prism as described in more detail below. The beam then strikes a green microdisplay unit 52. The microdisplay is a custom LCD display with custom drive electronics that can be used to reflect or absorb light or change the polarization of the light on a pixel by pixel basis. This element is known as a green microdisplay since it encounters green light only. However, each microdisplay unit is similar and operates in a similar manner.

Returning to the diagram, on a pixel by pixel basis, the microdisplay 52 alters the polarization of light ray 48. For simplicity, the light reflected from the microdisplay is labeled as beam 54 and is indicated as now having a P polarization. The beam 54 is then transmitted through the PBS2 since it has a P polarization and is shown as beam 56. The beam 56 then passes through a piece of spacer glass 58 that separates that PBSs from each other. The spacer glass corrects the path length of the light. The beam 56 enters a third PBS (PBS3) 60. Since it is still has P polarization, it is transmitted through the PBS element as beam 58. The beam 58 then exits PBS3 60 and enters a Green/Magenta wavelength specific polarization rotator unit 62. This wavelength specific polarization rotator unit rotates the polarization of the green light (to S polarization) and the green light beam passes through a linear polarizer 64 that removes any P polarization light. The green light then passes through a cover glass 66 that may be coated with an antireflective coating 68 and enter a projections lens 70 as beam 104.

Red and Blue Light

Returning to the P polarization beam 38 that results from PBS1 28, it exits PBS1 28 and enters a magenta dichroic 72. The magenta dichroic only transmits the P polarized magenta light which then impinges on a Blue/Red wavelength specific polarization rotator unit 74. The effect of the wavelength specific polarization rotator unit 74 is to rotate the polarization of the blue light and to not effect the polarization of the red light. Therefore, the light exits the wavelength specific polarization rotator and enters a fourth PBS (PBS4) 76. Due to the wavelength specific polarization rotator, the blue light is S polarized (indicated as 78) and the red light is P polarized (indicated as 80). The P polarized red light 80 is transmitted through the diagonal beam splitter of PBS4. The beam strikes a quarter waveplate 82 and strikes a red microdisplay 84 (whose function is similar to the green microdisplay described above) where the polarization of the red light beam is modulated on a pixel by pixel basis. For simplicity, a light beam 86 reflected from the microdisplay is shown as S polarized. This S polarized beam 86 once again encounters the diagonal beam splitter element in PBS4 and the S polarized beam is reflected down where the reflected beam is indicated as 88. Upon exiting PBS4, the S polarized red light ray 88 encounters a Red/Blue wavelength specific polarization rotator unit 90 which does not rotate the S polarization red light. The red light beam 88 then enters PBS3 60 where it is labeled 94. Because it is S polarized, it is reflected by the diagonal beam splitter element in PBS3 to the left. Upon exiting PBS3, the beam 94 encounters the Green/Magenta wavelength specific polarization rotator 62. This wavelength specific polarization rotator does not effect the state of polarization of the red light ray. The beam therefore passes through the linear polarizer 64 and the cover glass 66 and the AR face 68 of cover glass where it is added to the green light beam 104 and goes on to enter projection lens 70.

Returning to the S polarized blue light 78 in PBS4 76, the S polarized blue light is reflected upwards by the diagonal beam splitter element of PBS4 as beam 96 and is transmitted through a quarter waveplate 98 and encounters a blue microdisplay 100 (with a similar function as the green and red microdisplays described above). The effect of the microdisplay is to alter the polarization of the blue light on a pixel by pixel basis. For simplicity, the reflected light is indicated as a P polarized beam 102. The P polarized light is therefore transmitted through the diagonal in PBS4. The P polarized blue light 102 exits PBS4 and encounters the Red/Blue wavelength specific polarization rotator 90. This wavelength specific polarization rotator rotates the polarization of the blue light so that it is now S polarized. The beam then enters PBS3 60. The S polarized blue light is then reflected by the diagonal beam splitter element of PBS3. The blue light then encounters the Green/Magenta wavelength specific polarization rotator 62. The wavelength specific polarization rotator does not affect the polarization of the beam. The S polarized blue light is then transmitted through the linear polarizer 64, the glass cover 66 and the AR face 68 of cover glass where it joins the green and red light content already in beam 104 which goes on into the projection lens 70. Thus, the full color image is formed in the projection lens. Now, the handling of the unwanted “dump” light in the prism 20 will be described in detail.

Dump Light

During the splitting of the light by the PBSs, some light is generated that is not wanted and is undesirable. In PBS1 28, the incoming unpolarized light is incident on the diagonal beam splitter element of the PBS. As described above, the S polarization light 36 encounters the green dichroic 40 wherein the S polarized blue and the red spectral components 106 are reflected back into PBS1 as shown. The beam 106 reflect off the diagonal in PBS1 and return back to the light source. As described above, the P polarization 38 is transmitted by PBS1. Upon exiting PBS1, the beam encounters the magenta dichroic 72. The magenta dichroic reflects the P polarized green spectral component 108 back into PBS1 where the beam 108 is transmitted through the diagonal in PBS1 and returned back to the light source. These two “return paths” remove most of the unwanted light from the prism. By handling the “dump” light in this manner, the prism components do not get hot since there is no unwanted light that remains in the prism. In addition the primary source of polarization “pollution” is also removed.

As mentioned above, however, the PBSs are not perfect polarizers. After the light encounters the PBSs' diagonal several times as they must in the prism, both the S and P polarizations become slightly polluted (e.g., there is slight P polarization light in the S polarization light and vice-versa). To give further consideration to this point, several cases are reviewed. First, consider the P polarized magenta dump light 108. As indicated above, the majority of the light is returned to the source. But suppose the magenta dump light has S pollution. This S polarization component would be reflected by the diagonal and follow a path 110. To account for this light, it exits PBS1 through an anti-reflection coating 32 and is absorbed by a black Light Stop 112. Note that there is an air gap 114 between the light stop 112 and the AR coating 32. The air gap may be included to prevent any heat generated by the light stop 112 from entering the prism and affecting the functioning of the prism.

Next, consider the S polarized green dump light 106. As indicated above, the majority of the light is returned to the source. But suppose the green dump light has P pollution. This component would be transmitted by the diagonal and also follow the path 110 and it too would be dumped into Light Stop 112 and absorbed. In a similar manner, polluted light in PBS2 46 is dumped along path 116 into a Light Stop 118 and polluted light in PBS3 60 is dumped along a path 120 into a Light Stop 122. Note that PBS2 and PBS3 are further from the light source 22 than is PBS1. Therefore, it is thought that the energy of the polluted light in PBS2 and PBS3 will be lower than in PBS1. For this reason, the Light Stops 118 and 122 on PBS2 and PBS3 are shown without an air gap. If, of course, the energy is found to be sufficient to heat the prism, then an air gap can be included for PBS2 or PBS3 or both. Now, the operation of the quarter waveplates 50, 82 and 98 will be described in more detail.

As shown and described, a quarter waveplate 50, 82 or 98 is placed between the output face of the particular PBS and the front of the microdisplay in each of the three channels. The function of the waveplate is to improve the contrast ratio of the image. The means by which this improved contrast ratio is accomplished is two-fold and is discussed below.

Skew Ray Correction

Since a high degree of linear polarization is needed to produce an image with a high contrast ratio, the first technique is to improve the linear polarization of light rays/beams that exit the face of the PBS. The need for this improvement relates to a characteristic of a PBS which is that light rays that exit normal to the output face are linearly polarized to a high degree while light rays that exit at off-normal angles (e.g., skew rays at skew angles) have a slight elliptical polarization. The quarter waveplate may be used to correct this problem. In particular, either the fast axis or the slow axis of the quarter waveplate is aligned parallel to the normal ray polarization axis of the PBS. The specific value of the quarter waveplate is not too important. The important factor is the variation in its retardation with an off-normal angle ray. In practice it is found that the variation in the retardation of the quarter waveplate with angle is close to that required to convert the elliptical polarization of the off normal skew rays back to linear polarization.

Residual Retardation Compensation

Since zero residual retardation is needed to produce a black dark state and, hence, a good contrast ratio, the second technique is to compensate for the residual retardation found in the high voltage dark state of the microdisplay. The technique to “null” the residual retardation found in the high voltage dark state of the microdisplay utilizes what is called the Senarmont Compensation Technique as described in an article by A. F. Hallimond entitled “The Polarizing Microscope,” (Vickers Instruments, 1970) p70. The procedure is to insert a quarter waveplate between the output face of the PBS and the top of the microdisplay. To start with, one axis of the waveplate is aligned parallel to the normal output polarization axis of the PBS. The microdisplay is then energized into the dark state and the axis of the waveplate is rotated to produce the blackest possible dark state. In the current generation of microdisplays, this angle is typically less than 5°, but the value is dependent on the wavelength of the light. In this manner, the quarter waveplates desirably improve the contrast ratio of the image produced by the prism in accordance with the invention. Now, a second embodiment of the prism in accordance with the invention will be described wherein an in-line configuration is used with a displaced PBS1.

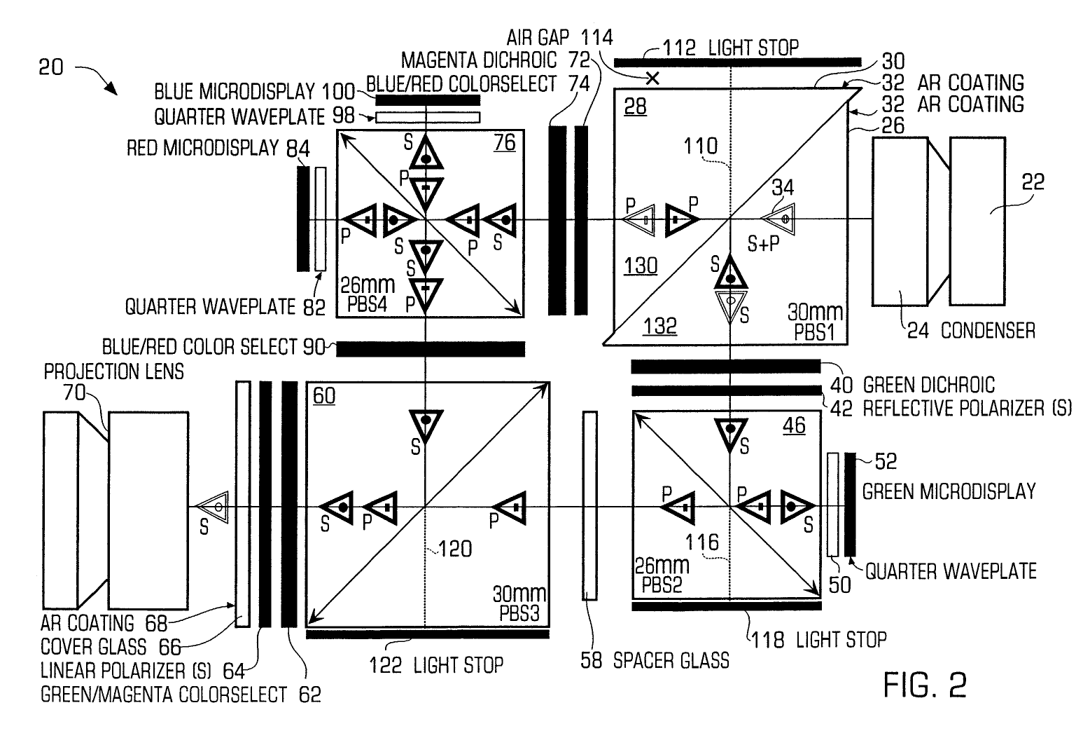

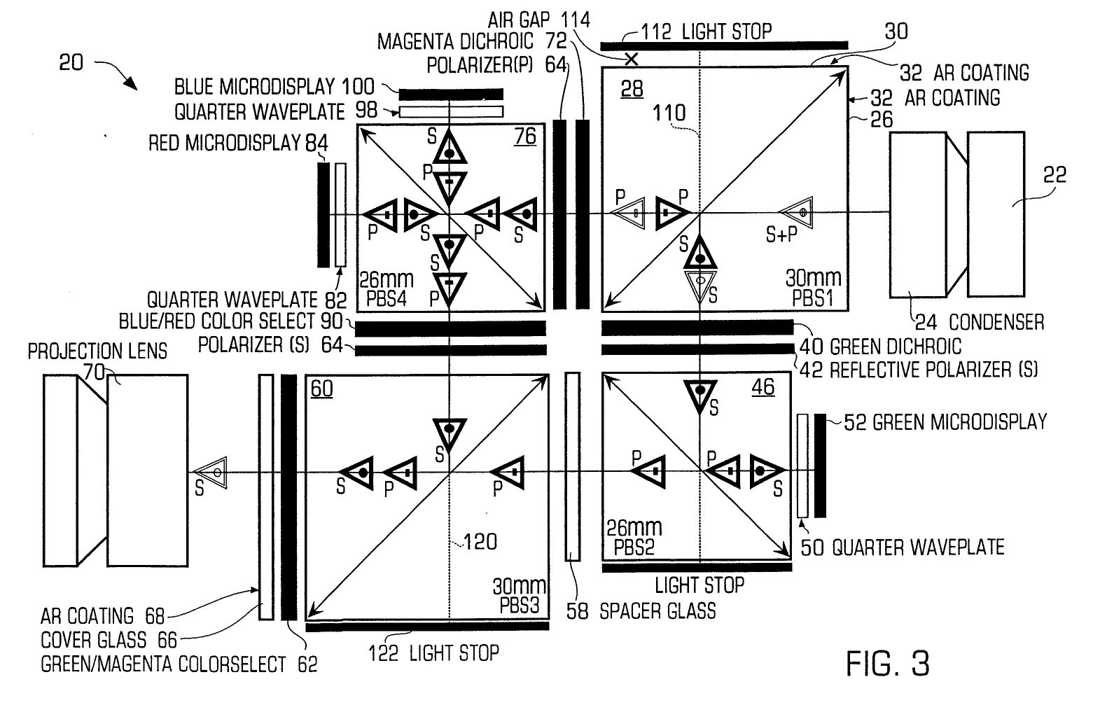

FIG. 2 is a diagram illustrating a second embodiment of the prism 20 in accordance with the invention having an in-line configuration with a displaced first polarizing beam splitter (PBS) 28. The path of the light components through this embodiment of the invention is similar to the first embodiment and therefore will not be described here. In addition, the elements of this embodiment of the prism in accordance with the invention are the same as the elements from the first embodiment so the elements will not be described herein. In addition, the light beams/rays is this embodiment follow the same path as the prior embodiment so that the light beams/rays will not be described and will also not be numbered to provide more clarity. In this embodiment, the various components of the prism 20 are spaced apart from each other as shown so that the light path lengths for all of the color components are matched. Thus, each light component beam will travel through the prism and reach the projection lens 70 having traveled approximately the same distance. In addition to the changing of the spacing of the components, the first PBS 28 has two portions 130, 132 that are offset from each other as shown. The two portion of PBS1 are offset so that the paths lengths for the different light paths are substantially equal. Similarly, FIG. 3 illustrates a third embodiment of the prism 20 wherein the spacing between the components of the prism are adjusted to provide an equal light path for each color component, but the input PBS1 is not displaced. Otherwise, the prism 20 shown in FIG. 3 has the same elements and operation as the prism 20 shown in FIGS. 1 and 2 and therefore the embodiment shown in FIG. 3 will not be described further. Now, another embodiment of the prism in accordance with the invention with a right angle configuration will be described.

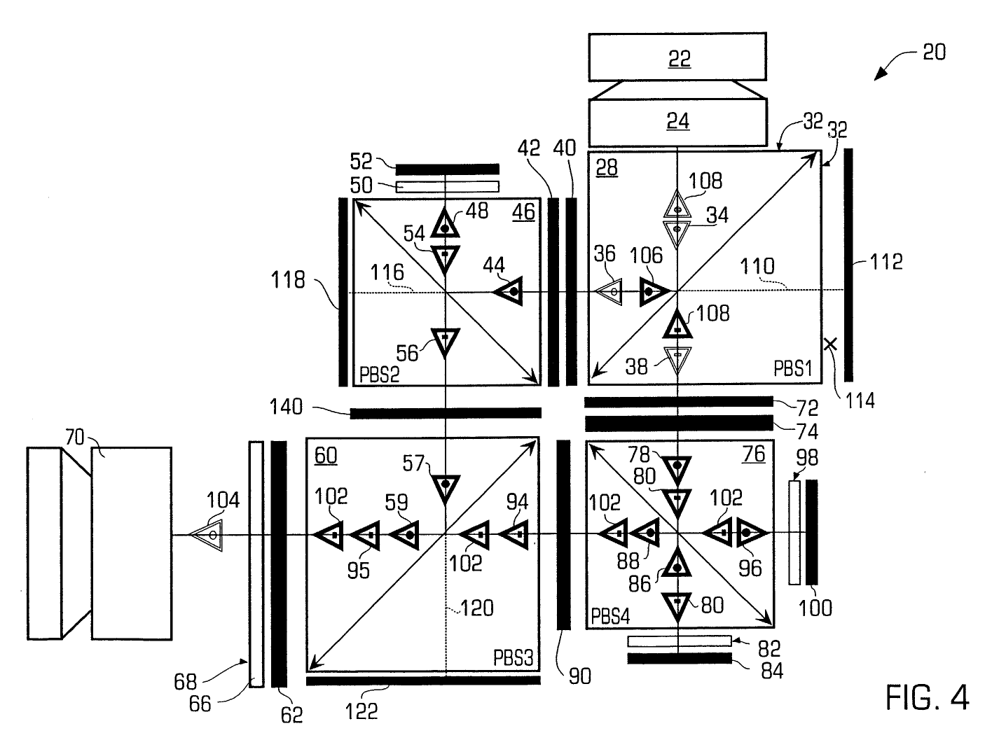

FIG. 4 is a diagram illustrating a fourth embodiment of the prism 20 in accordance with the invention having a right angle configuration wherein the elements of the prism are similar to the other embodiments although the position of the elements is slightly different due to the right angle configuration. In addition, the path followed by each color component is slightly different due to the right angle configuration. To better understand this embodiment, the path of each light component through the prism will be briefly described. As shown, the light source 22 and the condenser 24 produce a broad spectrum of unpolarized light 34 as indicated. As above, the unpolarized light is indicated as S+P wherein the S and P polarizations of the light are together. The light enters the polarizer beamsplitter (PBS1) 28 through the anti-reflection layer 32. Starting at this point, we will first trace the green light path and then the red and blue light path through the prism. Finally, we will go back to this same point and trace the “dump” light.

Green Light

For the green light path, the unpolarized white light 34 is incident on the diagonal of PBS1 and the S polarization 36 of the incoming light is reflected to the left. Upon exiting PBS1, the S polarization light passes through the green dichroic 40 where only the green portion of the spectrum is transmitted. The linear polarizer 42 “cleans-up” the light ray by removing the P polarization pollution introduced by PBS1. The transmitted, S polarized green light 44 enters PBS2 46. The green light is reflected upwards (light beam 48) by the diagonal in PBS2 (since it is S polarization light). The light then passes through the quarter waveplate 50 and onto the green microdisplay 52 that, on a pixel by pixel basis, effects the polarization of light ray 48 so that the light beam 54 reflected from the microdisplay now has a P polarization. The light beam 54 is transmitted through the diagonal of PBS2 without alteration and is shown as ray 56. The P polarized light ray 56 exits PBS2 and enters a Yellow/Blue wavelength specific polarization rotator 140 where its polarization is changed to S (see ray 57). The ray enters PBS3 60. The ray encounters the diagonal of PBS3 and is reflected to the left as ray 59. The ray exits PBS3 and enters the Green/Magenta wavelength specific polarization rotator 62 that does not effect the polarization of the ray. The ray goes on to exit through the anti-reflection outer surface 68 of the cover glass 66. The S polarized green ray, now labeled 104 goes on to enter projection lens 70.

Red Light

For the red light path, the unpolarized white light 34 is incident on the diagonal of PBS1 wherein the P polarization 38 is transmitted through the diagonal beam splitter element. When the ray exits PBS1, it encounters the magenta dichroic 72 which transmits only the P polarized magenta light that goes on to encounter the Blue/Red wavelength specific polarization rotator 74. The effect of the wavelength specific polarization rotator is to rotate the polarization of the blue light and to not effect the polarization of the red light. Therefore, upon entering PBS4 76, the blue light is S polarized (indicated as 78) and the red light is P polarized (indicated as 80).

The P polarized red light 80 is then transmitted through the diagonal in PBS4 and through the quarter waveplate 82. The ray 80 then encounters the red microdisplay 84 where the polarization is modulated on a pixel by pixel basis. For simplicity, the reflected light ray 86 is shown as S polarized. The ray once again encounters the diagonal in PBS4 and is reflected to the left (ray 88). Upon exiting PBS4, the S polarized red light ray 88 encounters the Red/Blue wavelength specific polarization rotator 90 that rotates the S polarization into P polarization (ray 94). The ray 94 goes on to enter PBS3 60. Because it is P polarized, the red light is transmitted through the diagonal (ray 95). Upon exiting PBS3, the ray 95 encounters the Green/Magenta wavelength specific polarization rotator 62 that does not effect the state of polarization of the red light ray. The ray, therefore exits from the AR face 68 of cover glass 66 where it to adds to the green already in 104 and goes on to enter projection lens 70.

Blue Light

For the blue light path, unpolarized white light 34 is incident on the diagonal of PBS1 and the P polarization 38 is transmitted. Upon exiting PBS1, the ray encounters the magenta dichroic 72 wherein the magenta light is transmitted. The light then encounters the Blue/Red wavelength specific polarization rotator 74 that rotates the P polarization light into S polarization light. The ray goes on to enter PBS4. The S polarized blue light is then reflected by the diagonal in PBS4 to the right (ray 96). This ray is then transmitted through the quarter waveplate 98 and encounters the blue microdisplay 100 that alters the polarization of the blue light on a pixel by pixel basis. For simplicity, the reflected light is indicated as P polarized (ray 102). The light is then transmitted through the diagonal in PBS4. The P polarized blue light 102 exits PBS4 and encounters the Red/Blue wavelength specific polarization rotator 90 that does not effect the polarization of the blue light. The ray, therefore, goes on to enter PBS3. The P polarized blue light is transmitted through the diagonal of PBS3 where it is labeled 102 and exits PBS3. The P polarized blue light encounters the Green/Magenta wavelength specific polarization rotator 62 that does not effect the polarization of the blue light. Thus, the P polarized blue light is transmitted through the AR face 68 of cover glass 66 where it joins the green and red light content already in ray 104 which goes on into projection lens 70.

Dump Light

As with the prior embodiments, the dump light is handled in a similar manner. In particular some of the light 108 is returned to the light source. In addition, the polluted light is absorbed by the light stop 112 for PBS1 along path 110, the polluted light in PBS2 is absorbed by light stop 118 along path 116 and the polluted light in PBS3 is absorbed by light stop 122 along path 120 as was described above in more detail. The operation of the quarter waveplates is similar to the previous embodiments and will not be described here. Now, a fifth embodiment of the prism in accordance with the invention will be described.

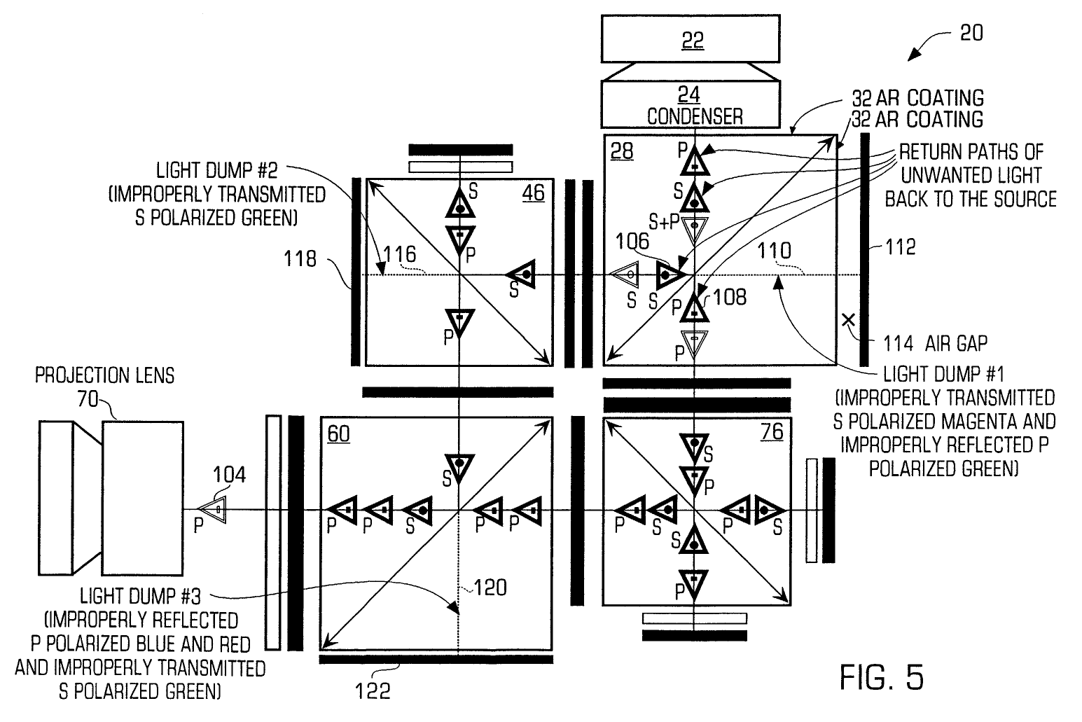

FIG. 5 is a diagram illustrating a fourth embodiment of the prism 20 in accordance with the invention having a right angle configuration wherein the waste light management described above is explicitly shown. To provide clarity, the reference numbers for all of the elements in this embodiment (which are the same as the fourth embodiment) will not be shown in this diagram. The return paths of light back to the light source are shown. In addition, the lights paths 110, 116 and 120 to the light stops 112, 118, 122, respectively, are shown. Now, a sixth embodiment of the prism in accordance with the invention will be described.

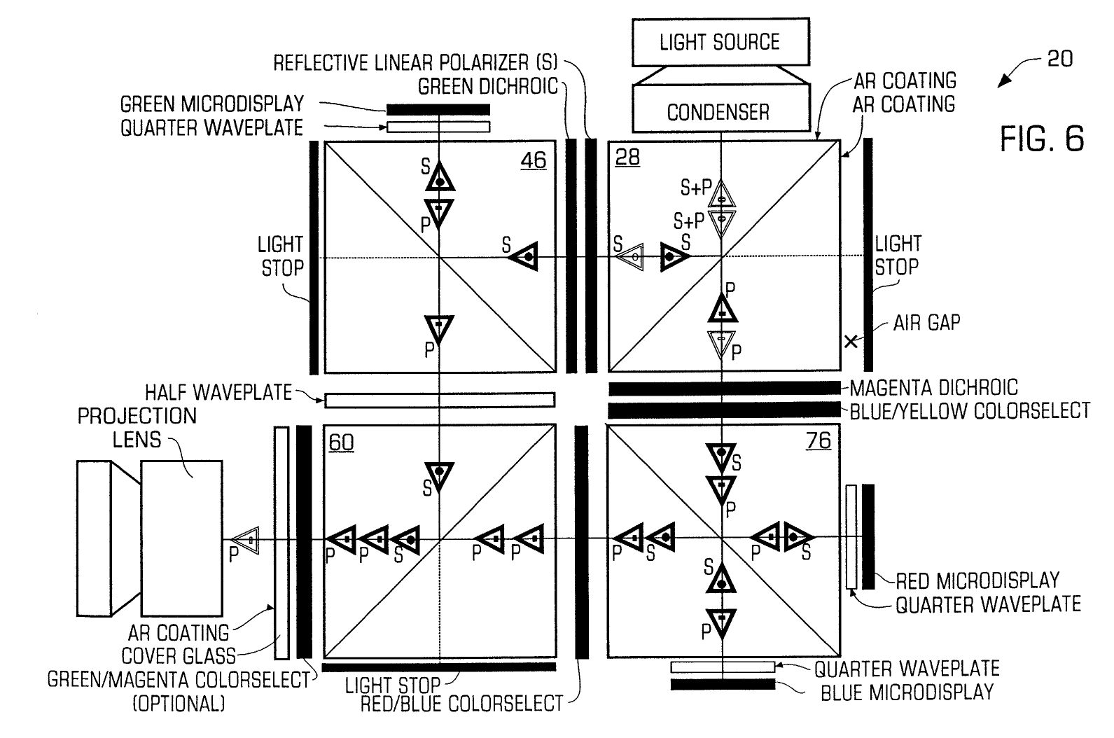

FIG. 6 is a diagram illustrating a fifth embodiment of the prism 20 in accordance with the invention having another right angle configuration. This embodiment of the prism has the same elements, configuration and operation as the previous embodiment and therefore this embodiment will not be described in any more detail. Now, another right angle embodiment will be described that is a preferred embodiment of the right angle configuration.

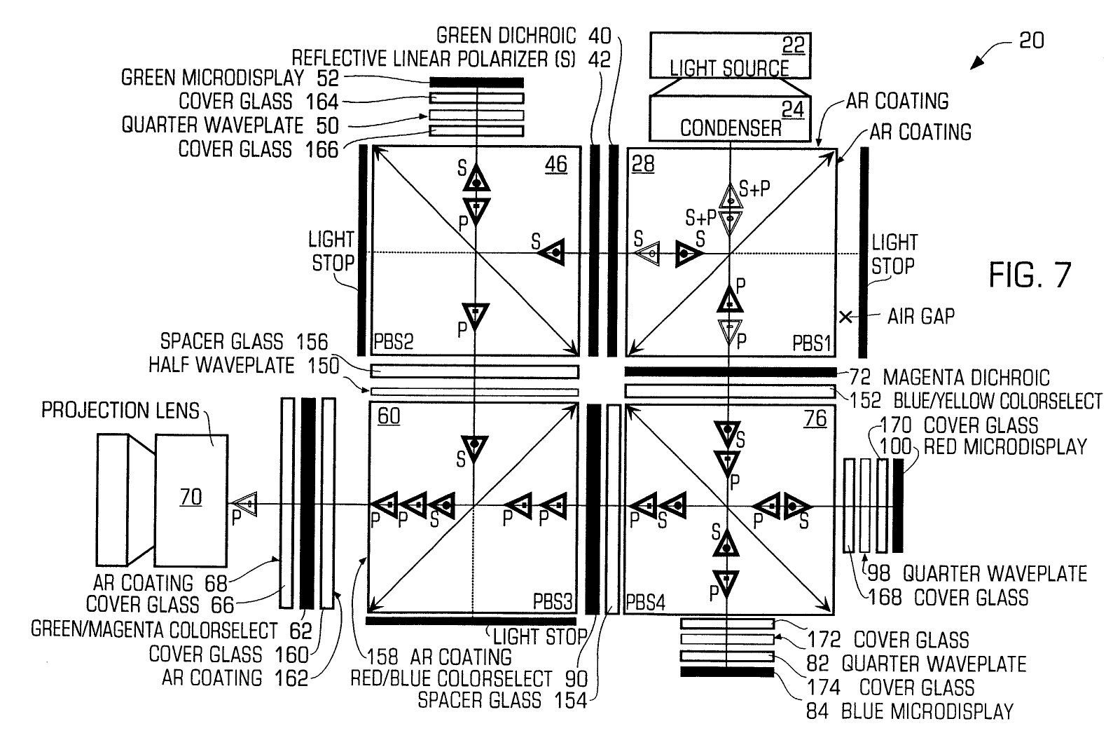

FIG. 7 is a diagram illustrating a sixth embodiment of the prism 20 in accordance with the invention having a preferred right angle configuration. For purposes of clarity, all of the reference numbers for the light paths will not be shown. The elements in common with the prior embodiments and their function will not be described. This embodiment, however, has some additional elements that will be described now. In particular, an inexpensive half waveplate 150 has been substituted for the expensive Green/Magenta wavelength specific polarization rotator. This substitution is possible because, at this location, only green light is present so it is not necessary for the material to control what happens in the red and blue portions of the spectra. In addition, the Blue/Red wavelength specific polarization rotator 74 has been replaced by a Blue/Yellow wavelength specific polarization rotator 152. In particular, since no green light is present at this location, there are not any spectral consequences in making a change from a blue/red to a blue/yellow device. The change is made because the contrast ratio of a Blue/Yellow wavelength specific polarization rotator is much higher than a Blue/Red wavelength specific polarization rotator.

In addition, glass spacers 154, 156 have been inserted next to the half waveplate 150 and the Red/Blue wavelength specific polarization rotator 90. The spacers 154, 156 equalize the optical distance in each color path and, to a large extent, the presence of the spacers 154, 156 mitigate the need for thick glue layers. In addition, an anti-reflective layer 158 is applied to the output face of the Star Prism. Thus, the Green/Magenta wavelength specific polarization rotator 62 may be added as a separate component only if the screen is polarized. To provide the wavelength specific polarization rotator 62 as a separate component, there may be a glass spacer 160 with an AR coating 162 attached to the wavelength specific polarization rotator. Furthermore, a pair of cover glass pieces 164, 166, 168, 170 and 172, 174 have been added on each side of the three quarter waveplates 50, 82, 98, respectively. This addition was found to facilitate handling during the manufacturing process.

In addition to the new elements, the four Polarizing Beam Splitting (PBS) cubes are made out of the high index glass, such as SF-1. This is done to minimize the cone angle of the light rays that travel through the glass and, hence, maximize the performance of the thin films. Furthermore, the thin film are designed to be broad band. The following two potential improvements are noted. First, the glass in the entrance PBS 28 is kept as expensive SF-1, but the glass in the other three cubes is changed to inexpensive BK-7. Preliminary calculations have shown that this substitution may not degrade contrast ratio or throughput. It may be possible to replace the expensive broad band thin film in the green PBS with a less expensive narrow band (green) thin film. This is possible because at this location only green light is present. Although less likely, it may be possible to replace the expensive broad band thin film in the red/blue PBS with a less expensive narrow band (red and blue) thin film. Now, a high light output configuration embodiment will be described.

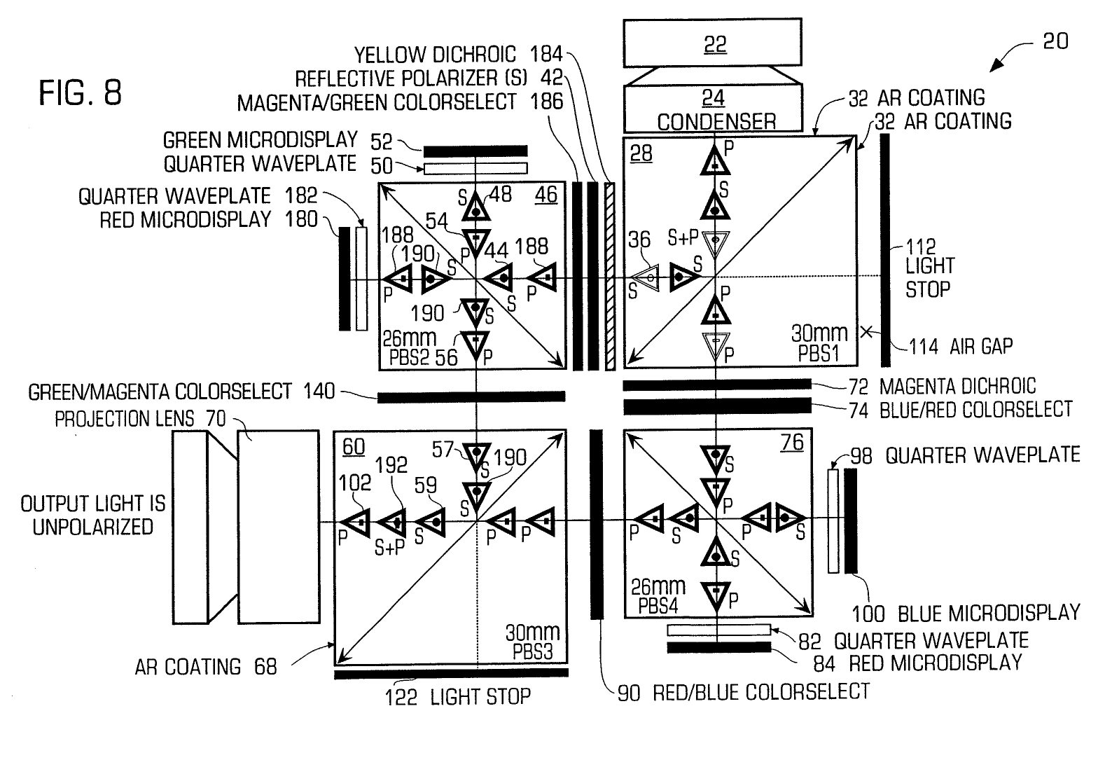

FIG. 8 is a diagram illustrating an seventh embodiment of the prism 20 in accordance with the invention having a high light output configuration. To better understand this embodiment, some background information is useful. In particular, the output of the light source 22, such as a UHP lamp, is low in the red portion of the spectrum. Therefore, it is typically necessary to reduce the brightness of the blue and green color channels in order to obtain a good white point where the brightness of the red, green and blue color components are equal. In practice, the brightness of the blue and green channels must be reduced by almost one half which greatly reduces the amount of light that can be projected onto the screen. The problem is that real projector products must put as much light as possible onto the screen. One approach to increasing the output of the prism 20 is illustrated in FIG. 7. The idea is to better utilize the red light already produced by the lamp so that it is not necessary to reduce the brightness of the green and blue color components.

Referring to FIG. 8, the same elements have the same functions and are denoted with the same reference numerals. For clarity, most of the light paths are not labeled with reference numerals, but the light paths are similar to the other described in earlier embodiments. New light paths, however, in this embodiment will be labeled and described. In this embodiment, a second red microdisplay 180 with a quarter waveplate 182 have been added to PBS2 46 which previously only had the green microdisplay 52. In this way, both polarizations of red light in this embodiment are utilized therefore doubling the red content in the image so that the blue and green components do not need to be reduced. In this configuration, the same information is put on both red microdisplays 84, 180 so that additional microdisplay electronics are not required. Using this embodiment, it is possible to double the useable red output of the lamp without any changes in the lamp or any increase in the light load of the prism.

In more detail, the S polarization light 36 from PBS1 28 passes through a yellow dichroic 184 (instead of a green dichroic) so that the yellow light is transmitted that includes the green component of the S polarized light as well as the red component of the S polarized light. The red and green components then pass through the reflective polarizer 42 that does not affect the polarization of the beams. The light components then pass through a magenta/green wavelength specific polarization rotator unit 186 that affects the polarization of the green and red components of the light. In particular, the polarization of the green light is unaffected so that S polarized green light 44 enters PBS2 46 while the polarization of the red line is rotated so that P polarized red light 188 enters PBS2.

Within PBS2, there are now two different light beams/rays including the red light ray and the green light ray. As described above, the green light ray 44 reflects off of the beam splitting element and is directed towards the quarter waveplate 50 and green microdisplay 52 where it is turned into P polarization light 54. The green light then follow the light path as described above. For the red light 188, it passes through the beam splitter element, passes through the quarter waveplate 182 and is reflected by the red microdisplay 180 where the polarization of the red light on a pixel by pixel basis occurs so that an S polarized ray 190 is generated. The S red light ray 190 is reflected by the beam splitter element. As it exits PBS2, it passes through the green/magenta wavelength specific polarization rotator 140 which rotates the polarization of the green light into S polarized green light 57 while the polarization of the red light is not changed and thus remains S polarized. The green and red light enter PBS3 60 and are reflected by the beam splitter element so that the green light 59 is sent towards the projection lens 70 through the AR coating 68 as described above. The S polarized red light 190 is then combined with the P polarized red light from PBS4 to generate a red light ray 192 with both S and P polarizations. Thus, both polarization components of the red light are used so that the blue and green components do not need to be reduced. Now, another embodiment of the invention with an air gap which is the preferred embodiment of the prism in accordance with the invention will be described.

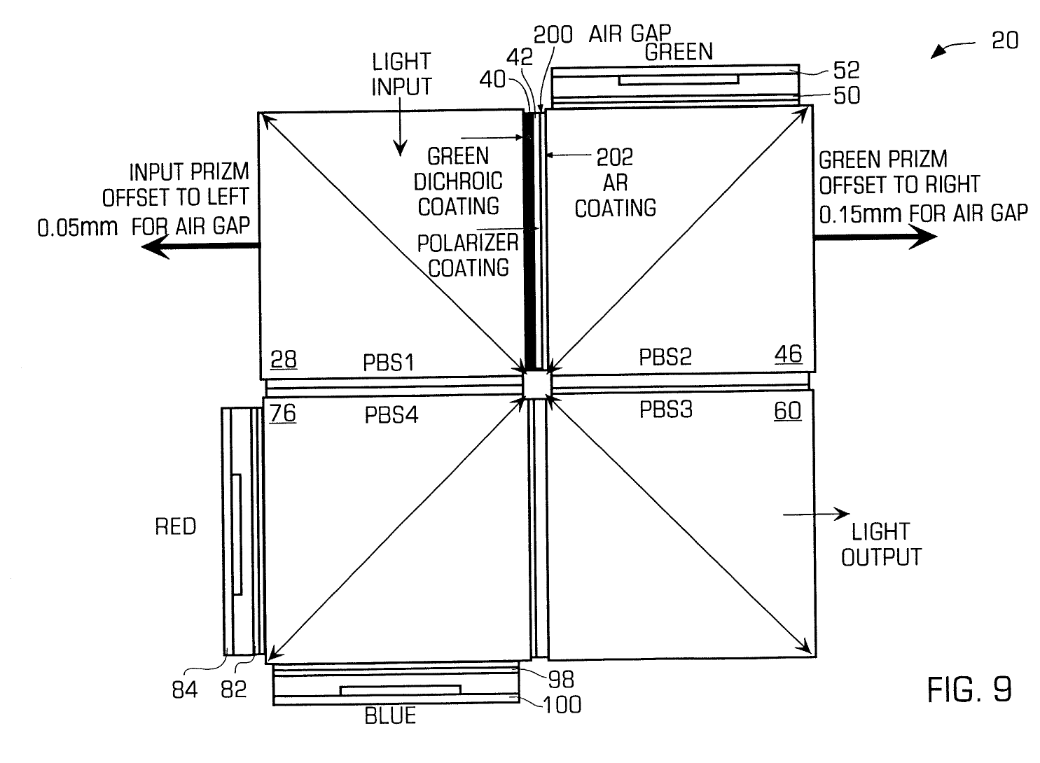

FIG. 9 is a diagram illustrating a eighth embodiment of the prism 20 in accordance with the invention having an air gap. In this embodiment, the paths of the light are not shown for clarity, but the operation of this embodiment should be understood based on the previous embodiments that have been described. This embodiment reduces the effect of residual light absorption and the consequent heating of the reflective polarizer. In particular, the wire grid elements of the reflective polarizer are made of aluminum and aluminum absorbs a small but significant fraction of the impinging light. In a high light flux environment, such as a projection image system, the absorption will cause the temperature of the polarizer to increase. This, in turn, causes the temperature of the adjacent prism components to increase. The resulting thermal gradient produces stress induced birefringence in the green prism. This condition is manifested in the projected image as an undesired variation in the blackness of what should be a uniform dark state. This embodiment of the prism partially solves this limitation.

In this embodiment, an air gap 200 has been introduced between the wire grid polarizer 42 and the green prism 46. An air gap of only 0.2 mm has been experimentally found to thermally isolate the reflective polarizer 40 from the green prism 46 and to eliminate the problem in a preferred embodiment. To accomplish this air gap in the preferred embodiment, the input prism 28 has been offset to the left by 0.05 mm and the green prism 46 has been offset to the right by 0.15 mm. To minimize light loss in the preferred embodiment, an anti-reflection coating 202 was added to the face of the green prism. In addition, the structure of the wire grid is itself an AR coating. One further point to note is that the extinction ratio of the wire grid polarizer is much higher in air than it is when immersed (as was the case in the previous embodiment without the air gap). In certain application it may be desirable to seal the perimeter of the air gap. This prevents contaminates from entering the gap and coating the glass surfaces. Now, two liquid filled embodiments of the prism 20 in accordance with the invention will be described.

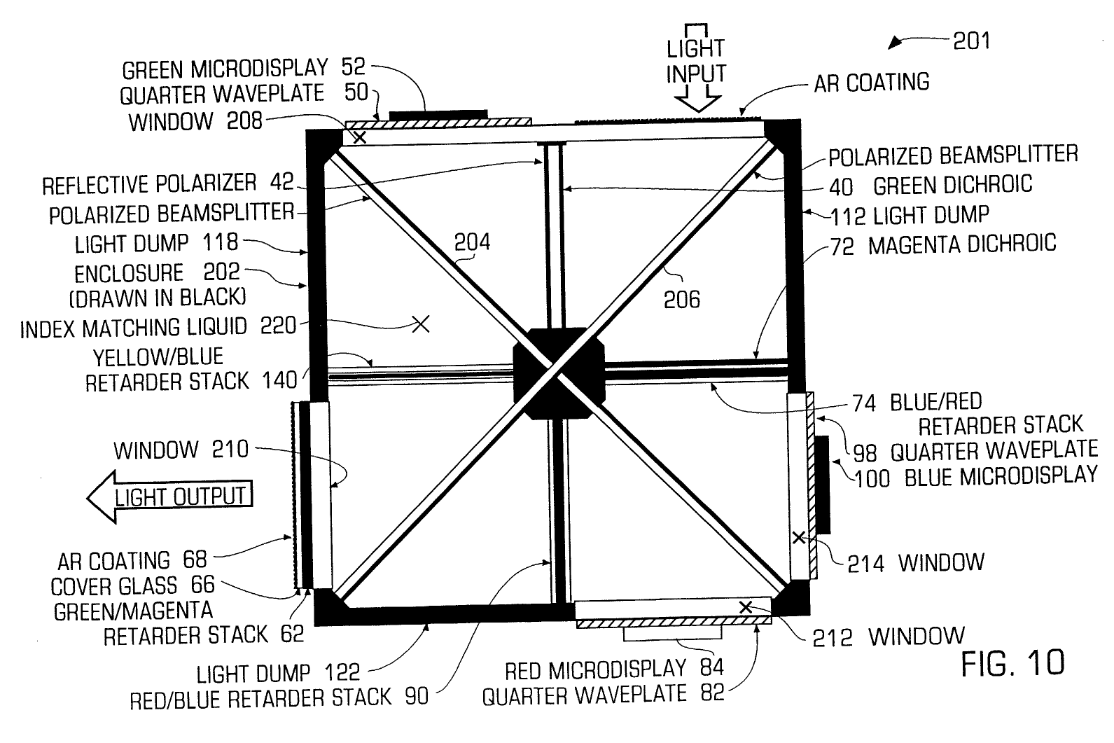

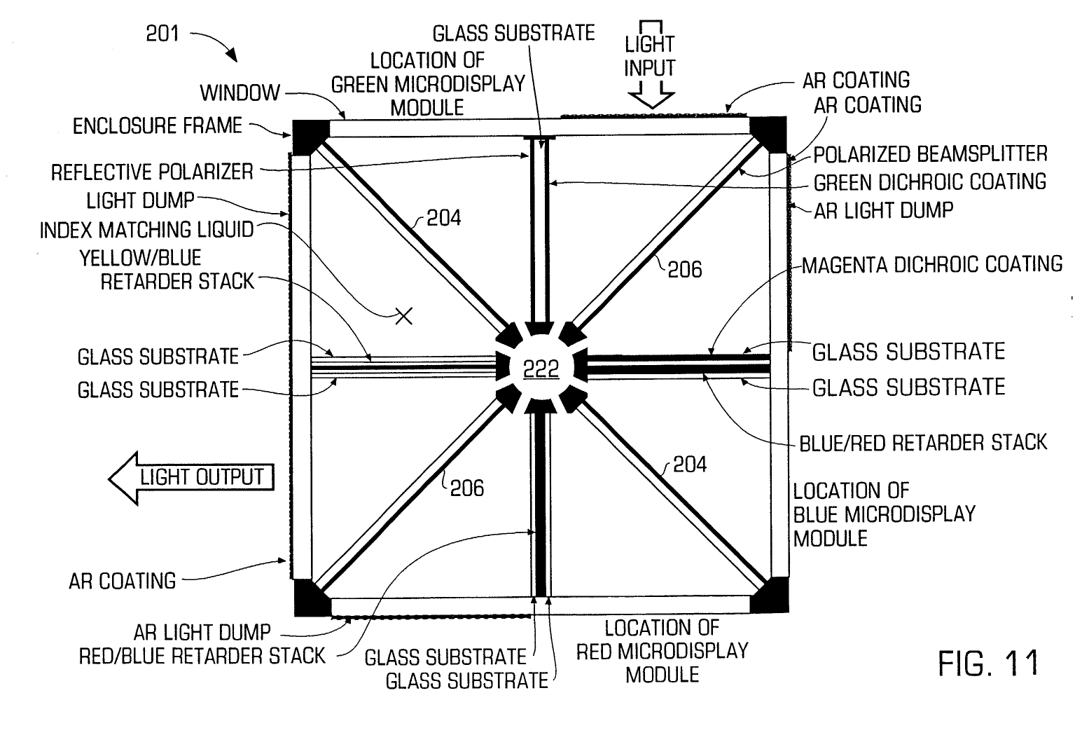

FIGS. 10 and 11 are diagrams illustrating a ninth and tenth embodiment of the prism 200 in accordance with the invention that is liquid filled. First, the general differences and advantages of this embodiment will be described and then the details of the liquid filled prism will be described. The most obvious change is that the PBS cubes have been removed and that coated glass plates (polarized beamsplitters) are used to split the polarization. An enclosure is used to hold all of the components in place and the enclosure is filled with an index matching liquid. This embodiment has some advantages. In particular, the part count of the prism 20 is reduced as is the amount of glass that is required which both reduce the cost of materials. In addition, the components are loaded into the “baseplate” which makes assembly easy, quick and inexpensive. All of the glue bonds that connected the PBS cubes together are eliminated which makes assembly easier and faster but, in addition, removes all possibility of stress between the components. In the embodiment shown in FIG. 11, windows are included to allow removal of the dump light which will reduce the heat load contained in the prism assembly. In the example shown in FIG. 11, three dump windows are illustrated, but less can be used if found appropriate. Also, if appropriate, cooling fins can be made a part of the enclosure at dump or other positions.

There are some additional and specific features of the liquid filled configuration. For example, as illustrated in both figures, it is possible to deposit and therefore combine the dielectric thin films with the outer surfaces of the clean up polarizer and with one of the cover glasses of the retarder stacks. Furthermore, the exit window can be used as the inner cover glasses of the exit retarder stack. This approach reduces the part count and, therefore, reduces assembly and material costs. In the figures, the beamsplitters are shown as two pieces that run the diagonal length of the enclosure. Not illustrated is the fact that both beamsplitters have a central notch to allow them to interdigitate. The advantage of this approach is that the number of components is reduced thus reducing assembly and material costs. A second advantage is that making the beamsplitters into long pieces guarantees the parallelism of the diagonal sections. A central “fill port” can be included in the enclosure which will facilitate bubble-less and rapid filling of the enclosure with the index matching liquid. If for any reason the liquid does not perfectly match the index of refraction of any of the immersed components, it should be possible to add an “anti-reflection” coating to the mismatched glass surface. Now, more details of the liquid filled prism 200 will be described.

As shown in FIG. 10, the prism 200 may include an enclosure 202 into which a first beam splitter element 204 and a second beam splitter element 206 are placed is a crossing relationship to each other as shown wherein the first and second beam splitter elements 204, 206 are notched so that they fit together. The enclosure may have one or more windows 208, 210, 212, 214 through which light may pass. For example, there is the window 208 through which the input light passes and the green light passes on its path to the quarter waveplate 50 and the green microdisplay 52. There is also a window 210 where the lights exits and windows 212, 214 through which red and blue light, respectively, pass on its path to the quarter waveplates 82, 98 and the red and blue microdisplays 84, 100. In accordance with the invention, the quarter waveplates and microdisplays are attached to the windows of the enclosure. Similarly, the green/magenta wavelength specific polarization rotator 62 and the cover glass 66 with the AR coating 68 are also attached to the window 210 of the enclosure. As described above, once the prism 200 has been manufactured it is filled with an index matching liquid 220 and sealed.

In the embodiment shown in FIG. 11, the elements are the same and will not be described here except that a central fill hole 222 is provided to more easily fill the liquid and the dichroic elements have been replaced with dichroic films that are coated onto a glass substrate.

In accordance with the invention, the embodiments of the prism described herein provide various advantages over the conventional prisms. In particular, the contrast ratio is enhanced through the use of “rotated” quarter waveplates located between each of the polarized beam splitters and the microdisplays. A simple modifications in the design will allow the f# to be optimized for various applications. The optical path lengths of the red, green and blue channels are designed to be equal which assures that the input light focuses on each microdisplay and that each microdisplay is in focus for the same position of the projection lens. In one embodiment, one or more spacer glass pieces are added (See FIG. 7) to adjust the optical path length (and so assure equal path lengths) is to include one or more spacer glasses. The specific thickness and location of the spacer glasses are chosen to equalize the path lengths. In another embodiment, the two triangular glass pieces of the prism that make up the PBS cubes are offset (See FIG. 2).

In most configurations, at least some of the prism components are glued together. The index of refraction of the glue is chosen to match that of the components which reduces light loss due to Fresnel reflections. In one configuration approach, the polarizer/retarder stacks are not glued to other components. Instead, the stacks are laminated between cover glasses and separated from the other components by air gaps (See FIG. 9) to reduce assembly and operational stress on the stacks. To implement this approach, the outer surfaces of the cover glasses (as well as the faces of adjacent components) are AR coated. The positions of the components are fixed by a base plate. In the design of the base plate the thickness of the air gaps between the components are chosen so as to equalize the optical path in each of the three channels.

In most configurations, the dichroic thin films can be coated onto a separate spacer glass or directly onto the PBS components and the back focal length is minimized in order to relax the requirements placed on the projection lens. In addition, the cost of the prism is kept low by minimizing the number of glass components. Component cost is farther minimized by utilizing simple triangular/square glass shapes. In addition, the light paths in the prism are designed such that the light is incident on the dichroics at a right angle which minimizes phase errors and chromatic effects. Furthermore, the “dump” and scattered light are effectively managed so as to prevent heating and in order to maintain a high contrast ratio. One possibility is to AR coat the dump face and place a black absorber a small distance from the face which eliminates any possibility of heating. The temperature of the light engine is controlled to prevent drift in the characteristics of the projected image. The physical size of the components have been adjusted in order to facilitate cost-effective, automatic assembly of the prism. Reflective UV/IR filters may be mounted at or on the input face of the prism to remove/reflect ultra violet and infrared light.

To increase contrast, it is possible to introduce one or more additional clean-up polarizers into the prism. The location of the clean-up polarizer in the preferred embodiment is in the green channel. This location was chosen to minimize the exposure of the material to harmful UV/blue light. The specific placement of clean-up polarizer(s) determines if the best choice is to use an absorptive or a reflective polarizer material. In the preferred embodiment we have chosen to use a reflective clean-up polarizer since the transmission of such polarizers is very high.

In accordance with the invention, various different prism configurations are possible. In particular, the prism can incorporate a reflective microdisplay that utilizes any one of several electro-optic effects including but not limited to: mixed mode TN, ferroelectric, surface mode and folded surface mode. The prism can incorporate microdisplays with a range of aspect ratios including but not limited to 4:3, 5:4, 16:9 and 16:10. The prism is compatible with a variety of light sources. This includes but is not limited to the Fusion Lighting ByteLight, the mercury arc lamp (with or without doping), metal halide, xenon, LED array, three color laser or light brought to the condenser by a fiber optic. The polarization of the red, green and blue light output by the prism/light engine can be independently controlled. One possibility is that all polarizations are along the same axis while allowing the use of a screen that includes a linear polarizer. The prism can be configured such that relationship between input and output light is either “in-line” or 90°. (Also note that it is possible to rotate the body of the light source around the long axes of the condenser. It is also possible to include a turning mirror in the condenser and by so doing aligning the body of the light source at 90° to the condenser. These configuration options allow a wide range of “packages” for the light engine.)

While the foregoing has been with reference to a particular embodiment of the invention, it will be appreciated by those skilled in the art that changes in this embodiment may be made without departing from the principles and spirit of the invention, the scope of which is defined by the appended claims.

1. A high efficiency prism for directing one or more color components of light to generate a color image, the prism comprising:
an input polarizing beam splitter for separating incoming unpolarized light into a beam having a first polarization and a beam having a second polarization;
a first color selection layer at the exit point of the first polarization beam for transmitting a first color light;
a first color polarizing beam splitter into which the first color light is received, the first polarizing beam splitter directing the first color light towards a first color microdisplay;
the first color microdisplay reflecting the first color light and changing its polarization to generate an altered first color beam;
a second color selection layer at the exit point of the second polarization beam for transmitting the second and third color light;
a second and third color polarizing beam splitter that receives the second and third color light, the second and third color polarizing beam splitter for directing the second color light towards a second microdisplay and for directing the third color light towards a third microdisplay;
the second microdisplay reflecting the second color light and changing its polarization to generate an altered second color light;
the third microdisplay reflecting the third color light and changing its polarization to generate an altered third color light;
an output polarizing beam splitter into which the altered first color beam, the altered second color beam and the altered third color beam are received, the third polarizing beam splitter recombining the altered color beams to generate a full color beam and directing the full color beam to an output.

2. The prism of claim 1 further comprising a dump light unit that discards unwanted light beams so that they do not become trapped in the prism and heat the prism.

3. The prism of claim 2, wherein the dump light unit further comprises a light path that directs unwanted light reflected by the color selection layers back into a light source so that the reflected unwanted light does not heat the prism.

4. The prism of claim 3, wherein the dump light unit further comprises a first light stop associated with the input polarizing beam splitter that absorbs unwanted light reflected by the color selection layers, a second light stop attached to the first color polarizing beam splitter that absorbs unwanted reflected light from the polarizing beam splitter and a third light stop attached to the output polarizing beam splitter that absorbs unwanted reflected light from the polarizing beam splitter.

5. The prism of claim 4, wherein the first light stop is separated from the input polarizing beam splitter by an air gap so that any heating of the first light stop by the light being absorbed does not heat the input polarizing beam splitter.

6. The prism of claim 1 further comprising a quarter waveplate inserted between each microdisplay and the corresponding polarizing beam splitter wherein the quarter waveplate increases the contrast ratio of the prism.

7. The prism of claim 6, wherein the first color selection layer comprises a green dichroic layer, the second color selection layer comprises a magenta dichroic layer, the first microdisplay reflects green light, the second microdisplay reflects blue light and the third microdisplay reflects red light.

8. The prism of claim 1, wherein the input polarizing beam splitter further comprises a first portion and a second portion that are offset from each other to correct the path lengths of the light components in the prism and wherein the elements of the prism are spaced apart from each other to correct the path lengths of the light components.

9. The prism of claim 6 further comprising a spacer glass located on each side of the quarter waveplates that corrects the light path lengths of the color components.

10. The prism of claim 1 further comprising a fourth microdisplay attached to the first color polarizing beam splitter that reflects the second color component having a different polarization and wherein the first color selection layer selects the first color light and the second color light.

11. The prism of claim 1, wherein the input polarizing beam splitter and the first color polarizing beam splitter are separated from each other by an air gap.

12. A high efficiency prism for directing one or more color components of light to generate a color image, the prism comprising:
an enclosure;
a first polarized beam splitter element attached to the enclosure;
a second polarized beam splitter element attached to the enclosure at substantially a right angle to the first polarized beam splitter element, the first and second polarized beam splitter elements separating the enclosure into four equal portions;
each portion further comprising a wall region in between the two polarized beam splitter elements, each wall region further comprising a color selection layer;
the enclosure having one or more transparent windows in the walls of the enclosure;
a first microdisplay connected to a window for reflecting light having a first color;
a second microdisplay connected to another window for reflecting light having a second color; and
a third microdisplay connected to another window for reflecting light having a third color.
